(19) United States
(12) Patent Application Publication
(10) Pub. No.: US 2021/0397119 A1
(43) Pub. Date: Dec. 23, 2021

(54) Recording Medium Detecting Device, Image Forming Device, Image Forming System, Recording Medium Detecting Method, And Non-Transitory Recording Medium Storing Computer Readable Program

(71) Applicant: Konica Minolta, Inc., Tokyo (JP)

(72) Inventors: Naoto SUGAYA, Tokyo (JP); Kenji TAMAKI, Tokorozawa-shi (JP); Kenji YAMAMOTO, Tokyo (JP); Tatsuo ISHIZUKA, Tokyo (JP)

(73) Assignee: Konica Minolta, Inc., Tokyo (JP)

(21) Appl. No.: 17/326,676

(22) Filed: May 21, 2021

(30) Foreign Application Priority Data
Jun. 22, 2020 (JP) 2020-106705

(51) Int. Cl. G03G 15/00; B65H 7/02

(52) U.S. Cl. CPC G03G 15/5029; G03G 15/5054; G03G 2215/00717; B65H 2220/01; B65H 2511/135; B65H 7/02

(57) ABSTRACT

The present invention provides a recording medium detecting device, an image forming device, an image forming system, a recording medium detecting method, and a non-transitory recording medium storing a computer readable program capable of detecting a grain direction of a recording medium. A recording medium detecting device has: a sensor capable of detecting a recording medium from a first detection direction and a second detection direction different from the first detection direction; and a control unit. The control unit determines a grain direction of a recording medium from first surface property data obtained when the recording medium is detected from the first detection direction and second surface property data obtained when the recording medium is detected from the second detection direction.

### CROSS-REFERENCE TO RELATED APPLICATIONS

The entire disclosure of Japanese Patent Application No. 2020-106705, filed on Jun. 22, 2020, is incorporated herein by reference in its entirety.

### BACKGROUND

### Technological Field

The present invention relates to a recording medium detecting device detecting a recording medium, an image forming device having a recording medium detecting device, an image forming system in which a recording medium detecting device and an image forming device are connected, a recording medium detecting method, and a non-transitory recording medium storing a computer readable program.

An image forming device has an image forming unit forming an image on a recording medium, and forms an image on a recording medium by using the image forming unit on the basis of job information which is output. Before forming an image in the image forming device, the size and the kind of a recording medium are detected by a recording medium detecting device.

There is conventionally a recording medium detecting device of this kind as described in, for example, Japanese Unexamined Patent Application Publication No. 2017-20869 (patent literature 1). Japanese Unexamined Patent Application Publication No. 2017-20869 (patent literature 1) discloses a technique having illuminating means including an illumination system illuminating an object such as a recording medium from oblique directions, detecting means including a detection system detecting each of a plurality of light rays reflected from the object in the directions different from one another, and a drive system changing the positions of the illumination system and the detection system.

A sheet as an example of a recording medium has grain directions of a T grain (longitudinal grain) and a Y grain (transverse grain) depending on the flow direction of fibers generated in a manufacturing process. In a sheet, small uneven parts occur along the flow direction of fibers. It is known that the amount of a curl occurring at the time of fixing varies depending on the differences of the grain direction of the flow of fibers even in sheets of the same kind.

### RELATED ART LITERATURE

### Patent Literature

### Patent Literature 1: Japanese Unexamined Patent Application Publication No. 2017-20869

### SUMMARY

In the technique described in Japanese Unexamined Patent Application Publication No. 2017-20869 (patent literature 1), however, although the kind of a recording medium can be detected, the grain direction which occurs in the recording medium is not detected. As a result, in the technique described in Japanese Unexamined Patent Application Publication No. 2017-20869 (patent literature 1), deterioration in the conveyance performance of a recording medium, the loading capacity of recording media, and appearance occurs depending on a change in the amount of a curl caused by variations of the grain direction.

In view of the conventional problem as described above, an object of the present invention is to provide a recording medium detecting device, an image forming device, an image forming system, a recording medium detecting method, and a non-transitory recording medium storing a computer readable program which are capable of detecting the grain direction of a recording medium.

To achieve at least one of the abovementioned objects, according to an aspect of the present invention, a recording medium detecting device reflecting one aspect of the present invention has a sensor and a control unit. The sensor can detect a recording medium from a first detection direction and a second detection direction which is different from the first detection direction. The control unit determines the grain direction of a recording medium from first surface property data obtained when the sensor detects the recording medium from the first detection direction and second surface property data obtained when the sensor detects the recording medium from the second detection direction.

The image forming device of the present invention has the above-described recording medium detecting device. In the image forming system of the present invention, the above-described recording medium detecting device is connected to the image forming device.

A method of detecting a recording medium according to an aspect of the present invention includes the following processes (1) to (3).

(1) a process of detecting a recording medium from a first detection direction

(2) a process of detecting the recording medium from a second detection direction different from the first detection direction

(3) a process of determining a grain direction of the recording medium on the basis of first surface property data obtained when the recording medium is detected in the first detection direction and second surface property data obtained when the recording medium is detected in the second detection direction

A non-transitory recording medium storing a computer readable program makes a computer execute the following processes:

detecting a recording medium from a first detection direction by a sensor;

detecting the recording medium from a second detection direction different from the first detection direction by the sensor; and

determining a grain direction of the recording medium by a control unit on the basis of first surface property data obtained when the recording medium is detected in the first detection direction and second surface property data obtained when the recording medium is detected in the second detection direction.

By the recording medium detecting device, the image forming device, the image forming system, the recording medium detecting method, and the non-transitory recording medium storing a computer readable program having the above configuration, the grain direction of a recording medium can be detected.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of limits of the present invention:

FIG. 1 is a schematic configuration diagram illustrating a general configuration of an image forming system according to a first embodiment of the present invention;

FIG. 2 is a block diagram illustrating a hardware configuration of the image forming system according to the first embodiment of the present invention;

FIG. 3 is a schematic configuration diagram illustrating a detecting unit of the image forming system according to the first embodiment of the present invention;

FIGS. 4A and 4B illustrate a detecting unit of the image forming system according to the first embodiment of the present invention; FIG. 4A is an explanatory diagram illustrating that the sensor is in a first arrangement state, and FIG. 4B is an explanatory diagram illustrating that the sensor is in a second arrangement state;

FIG. 5A is an explanatory diagram illustrating a recording medium in which the grain direction is the T direction, and FIG. 5B is a diagram illustrating a state that a recording medium of T grains is detected;

FIG. 6A is an explanatory diagram illustrating a recording medium in which the grain direction is the Y direction, and FIG. 6B is an explanatory diagram illustrating a state that a recording medium of Y grains is detected;

FIG. 7 is a graph illustrating the difference of detection light amounts when a recording medium of T grains and a recording medium of Y grains are detected;

FIG. 8 is a flowchart illustrating a first example of operation of detecting a recording medium in the image forming system according to the first embodiment of the present invention;

FIG. 9 is a table illustrating an example of a control parameter in the image forming system according to the first embodiment of the present invention;

FIG. 10 is an explanatory diagram illustrating a detecting unit in an image forming system according to a second embodiment of the present invention;

FIG. 11 is a flowchart illustrating operation of detecting a recording medium in the image forming system according to the second embodiment of the present invention;

FIG. 12 is a flowchart illustrating another example of the detecting operation;

FIG. 13 is a schematic configuration diagram illustrating a general configuration of an image forming system according to a third embodiment of the present invention;

FIG. 14 is a perspective view illustrating a recording medium detecting device in the image forming system according to the third embodiment of the present invention;

FIGS. 15A and 15B illustrate the recording medium detecting device in the image forming system according to the third embodiment of the present invention; FIG. 15A is an explanatory diagram illustrating a state that a recording medium is inserted from a first insertion direction, and FIG. 15B is an explanatory diagram illustrating a state that a recording medium is inserted from a second insertion direction;

FIG. 16 is a flowchart illustrating operation of detecting a recording medium in the image forming system according to the third embodiment of the present invention;

FIGS. 17A and 17B illustrate a modification of the recording medium detecting device in the image forming system according to the third embodiment of the present invention; FIG. 17A is an explanatory diagram illustrating that a sensor is in a first arrangement state, and FIG. 17B is an explanatory diagram illustrating that the sensor is in a second arrangement state; and

FIG. 18 is an explanatory diagram illustrating another modification of the recording medium detecting device in the image forming system according to the third embodiment of the present invention.

### DETAILED DESCRIPTION OF EMBODIMENTS

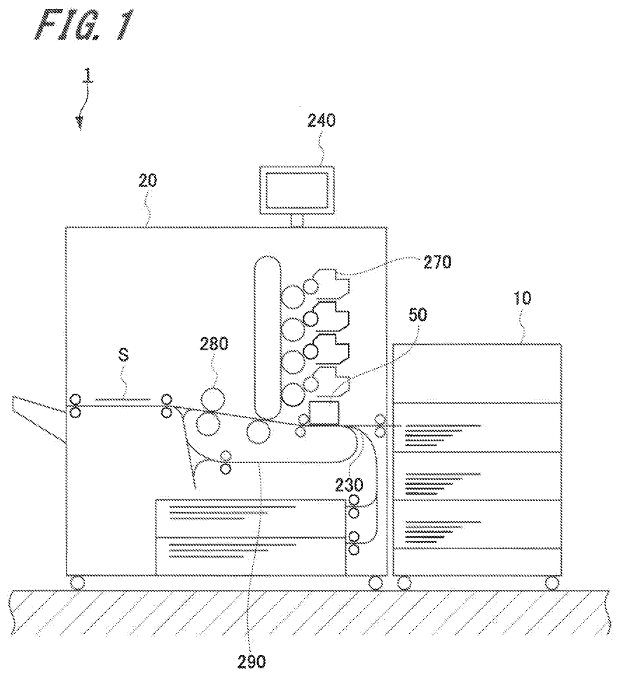

Hereinafter, modes for carrying out the present invention will be described with reference to FIGS. 1 to 18. In the specification and the drawings, the same reference numerals are designated to components which are common in the drawings. The present invention is not limited to the following embodiments.

### 1. Embodiments

### 1-1. Configuration of Image Forming System

First, a general configuration of an image forming system according to a first embodiment (hereinafter, called “the embodiment”) of the present invention will be described. FIG. 1 is a schematic configuration diagram of an image forming system 1 of the embodiment.

As illustrated in FIG. 1, the image forming system 1 has a sheet feeding unit 10 feeding a sheet S as an example of a recording medium and an image forming device 20. The sheet feeding unit 10 and the image forming device 20 are connected to a network such as an LAN and are connected to each other via the network. In the image forming system 1, the sheet feeding unit 10 and the image forming device 20 are arranged in order from the upstream side of the conveyance path of the sheet S and are connected in series.

The sheet feeding unit 10 is mounted on the uppermost stream side of the image forming system 1. The sheet feeding unit 10 has a plurality of sheet feeding trays and is configured so as to be able to house a large amount of sheets. The sheet feeding unit 10 feeds the sheets S housed in the sheet trays to the image forming device 20 by a sheet conveying unit.

Although an example that the image forming system 1 is provided with the sheet feeding unit 10 has been described, the present invention is not limited to the example. The sheet feeding unit 10 may not be provided for the image forming system 1.

The image forming device 20 forms an image on the sheet S which is fed on the basis of job information and image data which is output. The image forming device 20 is, for example, a device forming an image on the sheet S by the electrophotographic method. The image forming device 20 has a sheet conveying unit 230, an operation display panel 240, an image forming unit 270, a fixing unit 280, and a reverse conveying unit 290. The image forming device 20 has a detecting unit 50 detecting the kind, thickness, or the like of the sheet S. That is, in the image forming system 1 of the embodiment, the image forming device 20 is provided with the detecting unit 50.

The operation display panel 240 as a notifying unit is mounted on the casing of the image forming device 20. The operation display panel 240 has a configuration that a display panel and a touch panel (operation unit) are overlapped and can display an operation and information by the user.

The sheet conveying unit 230 conveys the sheet S fed from the sheet feeding unit 10 or the sheet feeding trays to the detecting unit 50, the image forming unit 270, the fixing unit 280, the reverse conveying unit 290, and a sheet ejection tray.

The image forming unit 270 has, for example, image forming units of a plurality of colors (cyan, magenta, yellow, and black, or the like) and can form a toner image of colors on a sheet. On the downstream side in the sheet conveying direction of the image forming unit 270, the fixing unit 280 to which the sheet on which the toner image is formed is conveyed is mounted.

The fixing unit 280 pressurizes and heats the sheet S conveyed, thereby fixing the toner image transferred to the sheet S onto the sheet S. The sheet S to which the fixing process is performed by the fixing unit 280 is conveyed to the reverse conveying unit 290 and the sheet ejection tray by the sheet conveying unit 230.

The reverse conveying unit 290 has a reversing unit reversing the sheet S. The sheet S turned upside down or changed its front/rear side by the reversing unit is conveyed through the reverse conveying unit 290 to the upstream side of the image forming unit 270 or the downstream side of the fixing unit 280.

The detecting unit 50 is a recording medium detecting device of an in-line type provided in the image forming device 20. The detecting unit 50 is mounted on the upstream side in the sheet conveying direction of the image forming unit 270 in the image forming device 20. The place to mount the detection unit 50 is not limited to the above-described place but may be, for example, in the ejection unit of the sheet feed tray housing the sheets S in the image forming device 20.

At the time of sheet setting process, the detecting unit 50 as an example of the recording medium detecting device conveys the sheet S conveyed from the sheet feeding unit 10 or the sheet feed tray and detects physical property values of the sheet S. The detecting unit 50 outputs the detected information to the image forming device 20.

The physical property values of the sheet S detected by the detecting unit 50 include, for example, basis weight, thickness, surface property, foundation, color, and the like. The detecting unit 50 also detects the grain direction of the sheet S as a physical property value of the sheet S.

### 1-2. Hardware Configuration of Devices

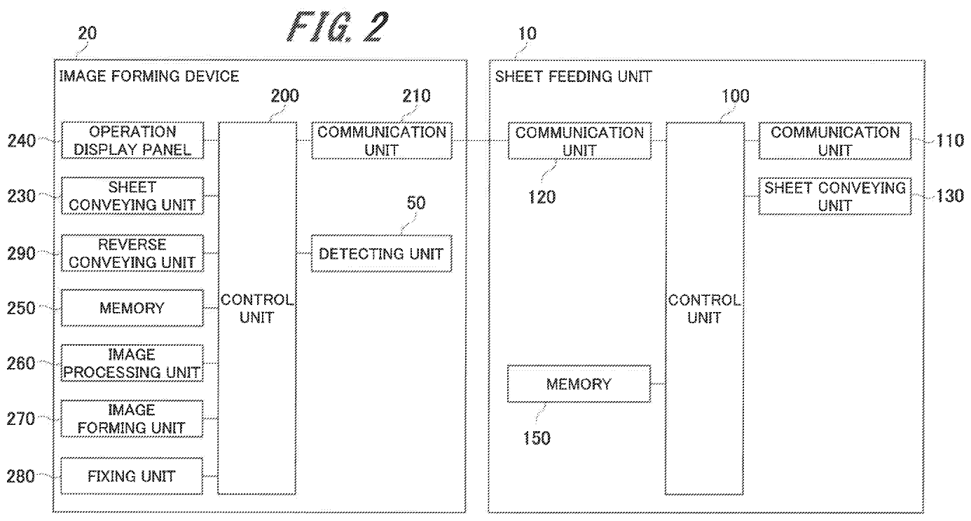

Next, the hardware configuration of each of the devices will be described with reference to FIG. 2.

FIG. 2 is a block diagram illustrating a hardware configuration of the devices in the image forming system.

First, the hardware configuration of the sheet feeding unit 10 will be described.

As illustrated in FIG. 2, the sheet feeding unit 10 has a control unit 100, communication units 110 and 120, a sheet conveying unit 130, and a memory 150.

The control unit 100 has, for example, a CPU (Central Processing Unit). The control unit 100 is connected to the communication units 110 and 120, the sheet conveying unit 130, and the memory 150 via a system bus and controls the entire sheet feeding unit 10.

The memory 150 is a volatile memory such as a RAM or a nonvolatile memory of large capacity. In the memory 150, a program and the like executed by the control unit 100 is stored. The memory 150 is used as a work area of the control unit 100.

The communication unit 110 transmits/receives data to/from external devices (client terminal, management device server, and the like, and mobile terminal) of the image forming system 1. The communication unit 120 transmits/receives data to/from a communication unit 210 of the image forming device 20.

Next, the hardware configuration of the image forming device 20 will be described.

The image forming device 20 has a control unit 200, the communication unit 210, the sheet conveying unit 230, the operation display panel 240, a memory 250, an image processing unit 260, the image forming unit 270, the fixing unit 280, the reverse conveying unit 290, and the detecting unit 50.

The control unit 200 as a determining unit has, for example, a CPU (Central Processing Unit). The control unit 200 is connected to the communication unit 210, the sheet conveying unit 230, the operation display panel 240, the memory 250, the image processing unit 260, the image forming unit 270, the fixing unit 280, and the reverse conveying unit 290 via a system bus, and controls the entire image forming device 20. The control unit 200 also controls the sheet feeding unit 10 and the detecting unit 50 via the communication unit 210. That is, in the embodiment, the control unit 200 controls the entire image forming system 1.

The memory 250 as a storing unit is a volatile memory such as a RAM or a nonvolatile memory of large capacity. In the memory 250, a program and the like to be executed by the control unit 200 is stored. The memory 250 is used as a work area of the control unit 200. In the memory 250, sheet setting information indicating the size and kind of the sheet S which is set is stored. The items of the sheet S to be set include, for example, the grain direction, base color, sheet type, basis weight, and the like of the sheet S.

The image processing unit 260 obtains image data from job information which is input from the outside and performs image process. Under control of the control unit 200, the image processing unit 260 performs image processes such as shading correction, image concentration adjustment, and image compression as necessary on received image data. The image data processed by the image processing unit 260 is transmitted to the image forming unit 270. The image forming unit 270 receives the image data processed by the image processing unit 260 and, on the basis of the image data, forms an image on the sheet S.

The operation display panel 240 is a touch panel made by a display such as a liquid crystal display (LCD) or an organic ELD (Electro Luminescence Display). The operation display panel 240 is an example of an output unit and an input unit and displays an instruction menu to the user, information regarding the obtained image data, and the like. Further, the operation display panel 240 has a plurality of keys, receives input of data such as various instructions, characters, figures, and the like by a key operation of the user, and outputs an input signal to the control unit 200.

The detecting unit 50 conveys the sheet S and detects the physical property values of the sheet S including the thickness and the grain direction of the sheet S. The information detected by the detecting unit 50 is transmitted to the control unit 200. On the basis of the information output from the detecting unit 50, the control unit 200 changes the control parameters to the sheet S.

### 1-3. Configuration Example of Recording Medium Detecting Device

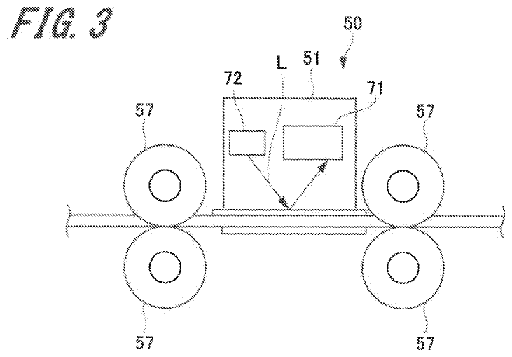

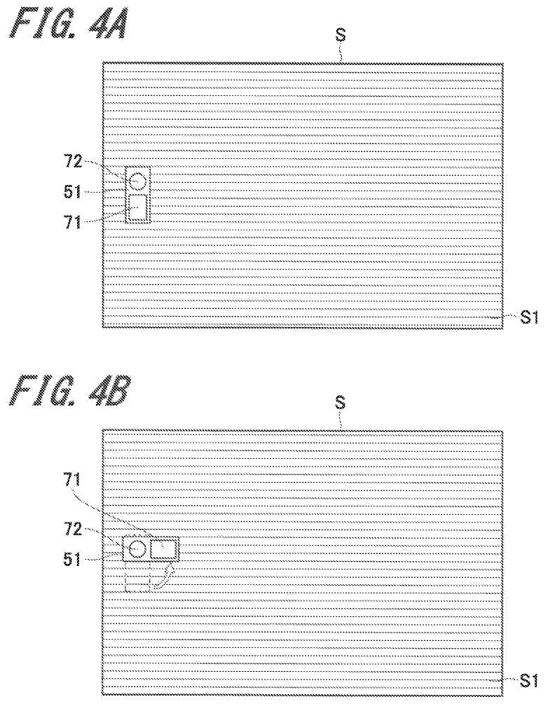

Next, the configuration of the detecting unit 50 as a recording medium detecting device will be described with reference to FIG. 3 and FIGS. 4A and 4B.

FIG. 3 is a schematic configuration diagram illustrating the detecting unit 50. FIGS. 4A and 4B illustrate a state that the detecting unit 50 detects the sheet S. FIG. 4A illustrates an example of detection in a first arrangement state, and FIG. 4B illustrates an example of detection in a second arrangement state.

As illustrated in FIG. 3, the detecting unit 50 has a sensor 51, a plurality of conveyance rollers 57, and a pair of conveyance guide plates. The pair of conveyance guide plates is opposed at a predetermined interval in the thickness direction perpendicular to both the conveyance direction of the sheet S and the width direction of the sheet S. The plurality of conveyance rollers 57 are mounted on the upstream and downstream sides in the conveyance direction in the sensor 51. The plurality of conveyance rollers 57 sandwich and convey the sheet S passing through the pair of conveyance guide plates.

The sensor 51 is mounted on one side in the thickness direction in the conveyance path in which the sheet S is conveyed. The sensor 51 has a light receiving unit 71 and a light emitting unit 72. The light emitting unit 72 emits light L toward the sheet S. The light receiving unit 71 receives the light L emitted from the light emitting unit 72 and reflected by the sheet S. On the basis of a light reception signal received by the light receiving unit 71, the sensor 51 detects the grain direction of the sheet S.

As illustrated in FIGS. 4A and 4B, the sensor 51 is supported movably by a not-illustrated moving mechanism. In the embodiment, the sensor 51 turns in the angle range of about 90 degrees in a plane which is in parallel to the conveyance direction of the sheet S.

When the moving mechanism drives, the arrangement state of the sensor 51 is changed between the first arrangement state and the second arrangement state. As illustrated in FIG. 4A, when the sensor 51 is in the first arrangement state, the light receiving unit 71 and the light emitting unit 72 are mounted along the direction perpendicular to the conveyance direction of the sheet S. Consequently, the light emitting unit 72 emits the light L in the direction perpendicular to the conveyance direction of the sheet S. When the sensor 51 is in the first arrangement state, the detection direction of the sensor 51 crosses the conveyance direction of the sheet S at right angles. The detection direction of the sensor 51 at this time is set as a first detection direction.

As illustrated in FIG. 4B, when the sensor 51 is in the second arrangement state, the light receiving unit 71 and the light emitting unit 72 are mounted along the direction parallel to the conveyance direction of the sheet S. Consequently, the light emitting unit 72 emits the light L in the direction parallel to the conveyance direction of the sheet S. When the sensor 51 is in the second arrangement state, the detection direction of the sensor 51 is parallel to the conveyance direction of the sheet S. The detection direction of the sensor 51 at this time is set as a second detection direction.

That is, when the sensor 51 is changed from the first arrangement state to the second arrangement state, the direction of light emitted to the sheet S, that is, the detection direction turns by 90 degrees. Consequently, the first and second detection directions cross at right angles.

As a moving mechanism of moving (changing) the arrangement state of the sensor 51, other various moving mechanisms such as a stepping motor and a solenoid can be applied. In the case of applying a stepping motor as the moving mechanism, by controlling the angle of the stepping motor, the sensor 51 is moved to the first and second arrangement states. In the case of applying a solenoid as the moving mechanism, for example, the sensor 51 is pulled from the first arrangement state to the second arrangement state in a state where the solenoid is on, and is reset from the second arrangement state to the first arrangement state in a state where the solenoid is off.

### 1-4. Grain Direction of Recording Medium and Variation of Detection Light Amount

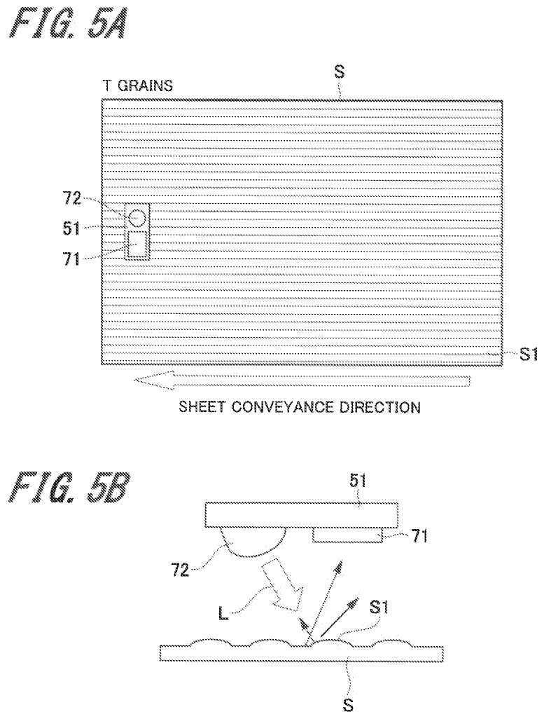

With reference to FIGS. 5A to 7, the grain direction of the sheet S as a recording medium and variation of the detection light amount received by the light receiving unit 71 will be described.

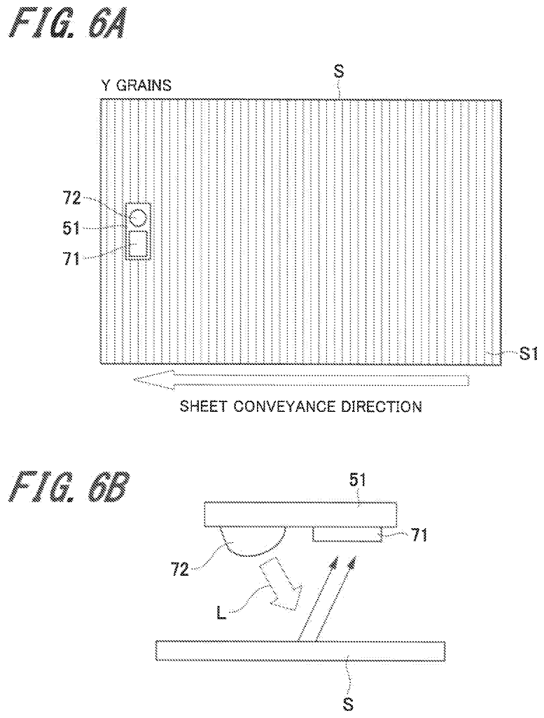

FIGS. 5A and 5B illustrate that the grain direction of the sheet S is the direction parallel to the conveyance direction, that is, the T grain. FIGS. 6A and 6B illustrate that the grain direction of the sheet S is the direction perpendicular to the conveyance direction, that is, the Y grain. FIGS. 5A and 6A are explanatory diagrams illustrating the sheet S, and FIGS. 5B and 6B are explanatory diagrams illustrating a state where the sheet S is detected. The arrangement state of the sensor 51 is the first arrangement state in all of FIGS. 5A to 6B. An example of detecting the sheet S in the first detection direction will be described.

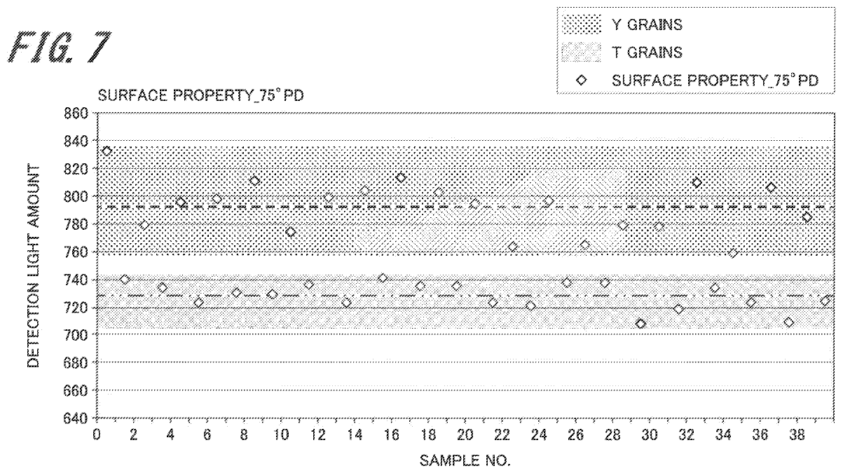

FIG. 7 is a graph illustrating the grain directions of the sheet S and variations of detection light amounts received by the light receiving unit 71. In FIG. 7, the vertical axis indicates detection light amount and the horizontal axis indicates sample numbers. Odd numbers in FIG. 7 indicate the sheets S of Y grains, and even numbers indicate the sheets S of T grains.

As illustrated in FIGS. 5A and 5B, when the grain direction of the sheet S is T grains, small uneven parts 51 occurring along the flow direction of the fibers of the sheet S are parallel to the conveyance direction. That is, when the sensor 51 is in the first arrangement state, the uneven parts S1 of the sheet S cross the detection direction of the sensor 51 at right angles.

As illustrated in FIG. 5B, in the case of the sheet S of T grains, the light L emitted from the light emitting unit 72 is irregularly diffused by the rough part S1 of the sheet S. Since the amount of light incident on the light receiving unit 71 decreases, the detection light amount of the light receiving unit 71 decreases as illustrated in FIG. 7.

On the other hand, as illustrated in FIGS. 6A and 6B, when the grain direction of the sheet S is Y grains, the small uneven parts S1 which occur along the flow direction of the fibers of the sheet S are perpendicular to the conveyance direction. That is, in the case where the sensor 51 is in the first arrangement state, the uneven parts S1 of the sheet S are parallel to the detection direction of the sensor 51.

As illustrated in FIG. 6B, in the case of the sheet S of Y grains, the light L emitted from the light emitting unit 72 is not easily irregularly reflected by the uneven parts S1 of the sheet S. Consequently, the amount of light incident on the light receiving unit 71 does not easily decrease and, as illustrated in FIG. 7, the detection light amount of the light receiving unit 71 becomes larger than that of the sheet S of T grains.

### 1-5. Detecting Operation of Recording Medium

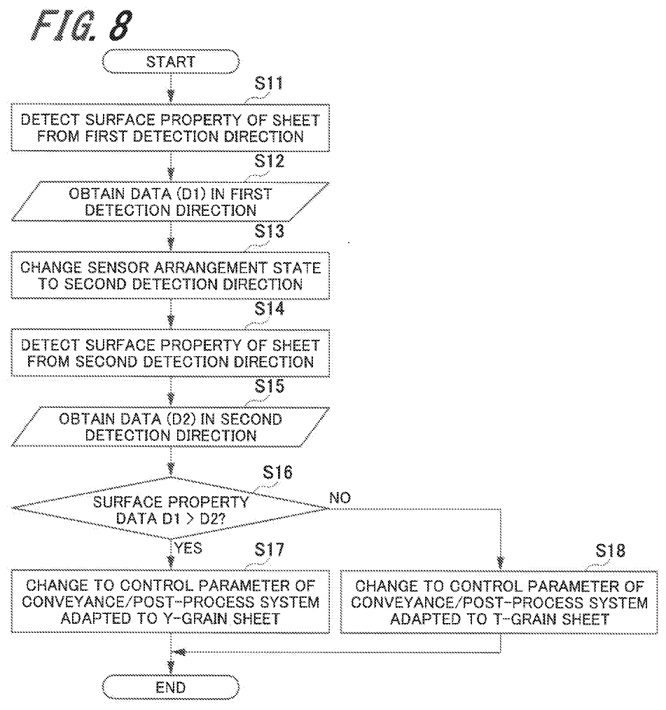

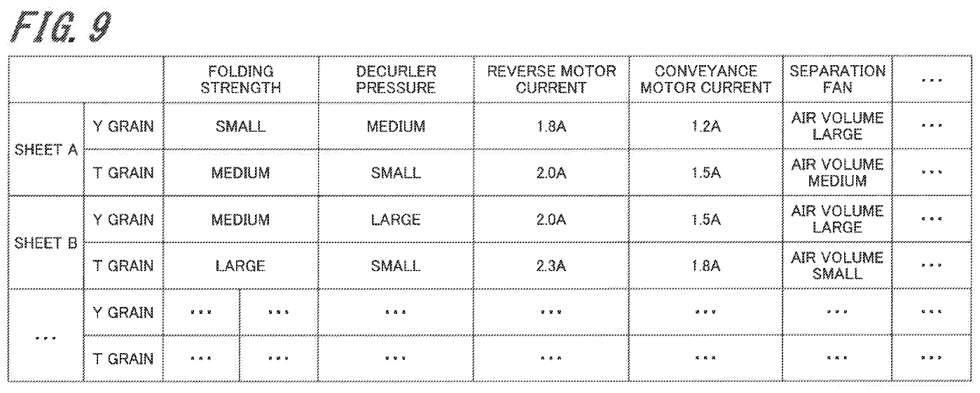

Next, an example of operation of detecting the sheet S as a recording medium in the image forming system 1 having the above-described configuration will be described with reference to FIGS. 8 and 9.

FIG. 8 is a flowchart illustrating an example of the detecting operation.

First, the control unit 100 of the sheet feeding unit 10 controls the sheet conveying unit 130 and feeds the sheet S to the image forming device 20. The control unit 200 of the image forming device 20 controls the sheet conveying unit 230 and carries the sheet S fed from the sheet feeding unit 10 to the detecting unit 50. When the sheet S is conveyed to the detecting unit 50, the control unit 200 temporarily stops the conveyance of the sheet S.

As illustrated in FIG. 8, the control unit 200 controls the detection unit 50 and detects the surface properties of the sheet S (step S11). In the process of step S11, the sensor 51 is in the first arrangement state, and the sensor 51 detects the surface properties of the sheet S in the first detection direction.

Subsequently, the control unit 200 obtains data detected from the detecting unit 50 in the process of step S11, that is, surface property data (hereinbelow, called first surface property data) D1 detected in the first detection direction by the sensor 51 (step S12). After obtaining the first surface property data D1, the detecting unit 50 or the control unit 200 drives the moving mechanism to change the arrangement state of the sensor 51 to the second arrangement state (step S13).

When the arrangement state of the sensor 51 is changed to the second arrangement state, the control unit 200 controls the detecting unit 50 to detect the surface properties of the sheet S from the second arrangement state (step S14). That is, the sensor 51 detects the surface properties of the sheet S from the second detection direction.

The operation of detecting the surface properties of the sheet S in the process of step S11 and the process of step S14 is performed in a state where conveyance of the sheet S is stopped. Consequently, variations of the interval between the sheet S and the sensor 51 caused by conveyance can be prevented. Therefore, the detection precision in the detecting unit 50 can be improved. The processes from step S11 to step S14 may be performed while conveying the sheet S.

The control unit 200 obtains data detected in the process of step S14, that is, surface property data (hereinbelow, second surface property data) D2 detected in the second detection direction by the sensor 51 from the detecting unit 50 (step S15). The control unit 200 determines whether or not the value of the first surface property data D1 is larger than that of the second surface property data D2 (step S16).

When it is determined in the process of step S16 that the value of the first surface property data D1 is larger than that of the second surface property data D2 (YES determination in step S16), the control unit 200 determines that the grain direction of the sheet S is the Y grain perpendicular to the conveyance direction. The control unit 200 changes the control parameter to the control parameter of a conveyance/post-process system adapted to the sheet S of Y grains (step S17).

On the other hand, when it is determined in the process of step S16 that the value of the first surface property data D1 is not larger than that of the second surface property data D2 (NO determination in step S16), the control unit 200 determines that the grain direction of the sheet S is T grain parallel to the conveyance direction. The control unit 200 changes the control parameter to the control parameter of the conveyance/post-process system adapted to the sheet S of T grain (step S18). It completes the operation of detecting the sheet S by the image forming system 1.

FIG. 9 is a parameter setting table illustrating an example of control parameters. Sheet A in FIG. 9 indicates thin paper and sheet B indicates thick paper. The parameter setting table illustrated in FIG. 9 is stored, for example, in the memory 250. Various control parameters are preliminarily set by the kinds of the sheet S and the grain directions. The various parameters may be set not only by the kinds of the sheets S but also by the basis weights or sizes.

“Folding strength” in FIG. 9 is strength at the time of folding the sheet S in a post-process device mounted on the downstream side of the image forming device 20. FIG. 9 illustrates an example that a folding line is formed in a direction perpendicular to the conveyance direction of the sheet S.

“Decurler pressure” is a pressing amount of the sheet S by a decurling mechanism which corrects a curl of the sheet S. “Reverse motor current” is a current value to the drive motor which drives a conveyance roller provided for the reverse conveying unit 290, and “conveyance motor current” is a current value to a drive motor which drives a conveyance roller provided for the sheet conveying unit 230. “Separation fan” indicates an air volume of a fan provided for the sheet feeding unit 10 and for separating the sheets S stacked on the tray.

In the process of folding the sheet S, the sheet S is easily curled along the fibers of the sheet S. Consequently, the “folding strength” of the sheet of Y grain is set to be smaller than that of the sheet of T grain. Since the sheet S is easily curled along the fibers, the “decurler pressure” of the sheet of Y grain is set larger than that of the sheet of T grain.

In the case where the conveyance direction and the grain direction of the sheet S are the same, that is, parallel to each other, the sheet S is not easily conveyed along the conveyance path and the load of the conveyance motor increases. Consequently, “reverse motor current” and “conveyance motor current” in a sheet of T grain are set larger than those of a sheet of Y grain. The sheets S are not easily separated from each other depending on a curl amount. In the example illustrated in FIG. 9, the air volume of the “separation fan” for a sheet of Y grain is set to be larger than that of a sheet of T grain.

The control parameters of the process performed on the sheet S are not limited to the example illustrated in FIG. 9. Other various control parameters of such as nip pressure in the fixing unit 280 and transfer and separation currents in the image forming unit 270 can be applied.

In the image forming system 1 of the embodiment, the grain direction of the sheet S can be detected as a physical property value of the sheet S. As illustrated in FIG. 9, by changing the various control parameters in accordance with the grain direction of the sheet S, the conveying process, stacking process, and the like adapted to the grain direction of the sheet S can be performed, and the precision and efficiency of the various processes such as conveyance performance and loading capacity of the sheet S can be improved.

Although an example of turning the sensor 51 by 90 degrees and setting the first and second detection directions cross at right angles in the detecting unit 50 of the embodiment has been described, the present invention is not limited to the example. The angle of turning of the sensor 51 may be less than 90 degrees and the first and second detection directions in the sensor 51 may just cross each other. By crossing the first and second detection directions at right angles, the difference between the first surface property data D1 and the second surface property data D2 is increased, and the detection precision can be increased.

### 2. Second Embodiment

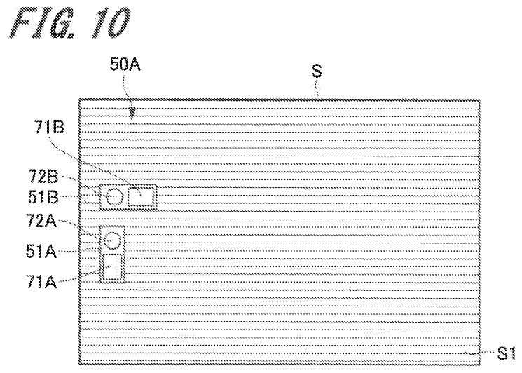

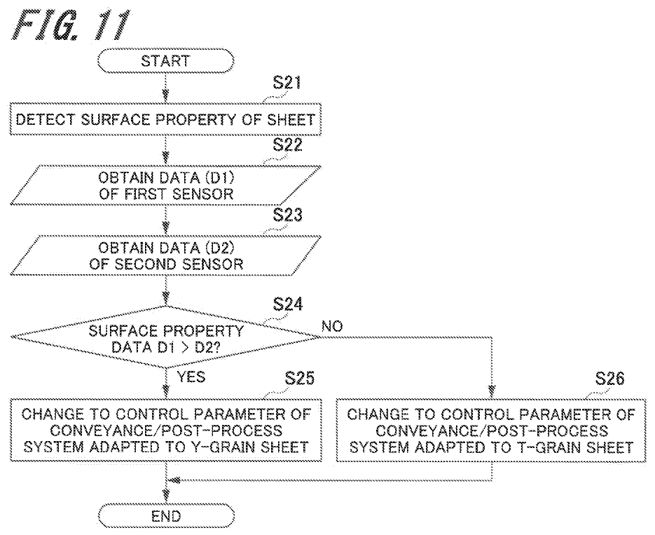

Next, an image forming system according to a second embodiment will be described with reference to FIGS. 10 and 11.

FIG. 10 is an explanatory diagram illustrating a detecting unit in the image forming system according to the second embodiment.

The point of the image forming system according to the second embodiment different from the image forming system 1 according to the first embodiment is the configuration of a detecting unit as a recording medium detecting device. Therefore, the detecting unit will be described here, and the same reference numerals are designated to parts common to those of the image forming system 1 according to the first embodiment, and repetitive description will not be given.

As illustrated in FIG. 10, a detecting unit 50A has a first sensor 51A and a second sensor 51B. The first sensor 51A has a first light receiving unit 71A and a first light emitting unit 72A. The first light receiving unit 71A receives light emitted from the first light emitting unit 72A and reflected by the sheet S. The first light receiving unit 71A and the first light emitting unit 72A of the first sensor 51A are mounted along a direction perpendicular to the conveyance direction of the sheet S like the first arrangement state of the sensor 51 according to the first embodiment. That is, the detection direction of the first sensor 51A crosses the conveyance direction of the sheet S at right angles. The detection direction of the first sensor 51A is set as a first detection direction.

The second sensor 51B has a second light receiving unit 71B and a second light emitting unit 72B. The second light receiving unit 71B receives light emitted from the second light emitting unit 72B and reflected by the sheet S. The second light receiving unit 71B and the second light emitting unit 72B of the second sensor 51B are mounted along a direction parallel to the conveyance direction of the sheet S like the second arrangement state of the sensor 51 according to the first embodiment. That is, the detection direction of the second sensor 51B is parallel to the conveyance direction of the sheet S. The detection direction of the second sensor 51B is set as a second detection direction.

Although the example that the first detection direction of the first sensor 51A and the second detection direction of the second sensor 51B cross at right angle has been described, the present invention is not limited to the example. It is sufficient that the first detection direction of the first sensor 51A and the second detection direction of the second sensor 51B cross each other.

Next, operation of detecting a sheet in the image forming system according to the second embodiment will be described with reference to FIG. 11.

FIG. 11 is a flowchart illustrating an example of detecting operation. Also in the image forming system according to the second embodiment, after the sheet S is conveyed to the detecting unit 50A, the conveyance of the sheet S is temporarily stopped, and the detecting operation is performed.

As illustrated in FIG. 11, the control unit 200 controls the detecting unit 50A to detect the surface property of the sheet S by using the first sensor 51A and the second sensor 51B (step S21). Specifically, the surface property of the sheet S is detected from the first detection direction by using the first sensor 51A and the surface property of the sheet S is detected from the second detection direction by using the second sensor 51B.

Subsequently, the control unit 200 obtains the surface property data (hereinafter, called first surface property data) D1 detected by the first sensor 51A (step S22). The control unit 200 obtains the surface property data (hereinafter, called second surface property data) D2 detected by the second sensor 51B (step S23).

When the first surface property data D1 and the second surface property data D2 are obtained, the control unit 200 determines whether the value of the first surface property data D1 is larger than that of the second surface property data D2 or not (step S24). When it is determined in the process of step S24 that the value of the first surface property data D1 is larger than that of the second surface property data D2 (YES determination in step S24), the control unit 200 determines that the grain direction of the sheet S is Y grain which is perpendicular to the conveyance direction. The control unit 200 changes the control parameter to the control parameter of the conveyance/post-process system adapted to the sheet S of Y grain (step S25).

On the other hand, when it is determined in the process of step S24 that the value of the first surface property data D1 is not larger than that of the second surface property data D2 (NO determination in step S24), the control unit 200 determines that the grain direction of the sheet S is T grain which is parallel to the conveyance direction. The control unit 200 changes the control parameter to the control parameter of the conveyance/post-process system adapted to the sheet S of T grain (step S26). It completes the operation of detecting the sheet S by the image forming system.

Since the other configuration is similar to that of the image forming system 1 according to the first embodiment, its description will not be repeated. The image forming system provided with the detecting unit 50A having the configuration as described above can also have action and effect similar to those of the image forming system 1 according to the first embodiment.

### 3. Another Example of Detecting Operation

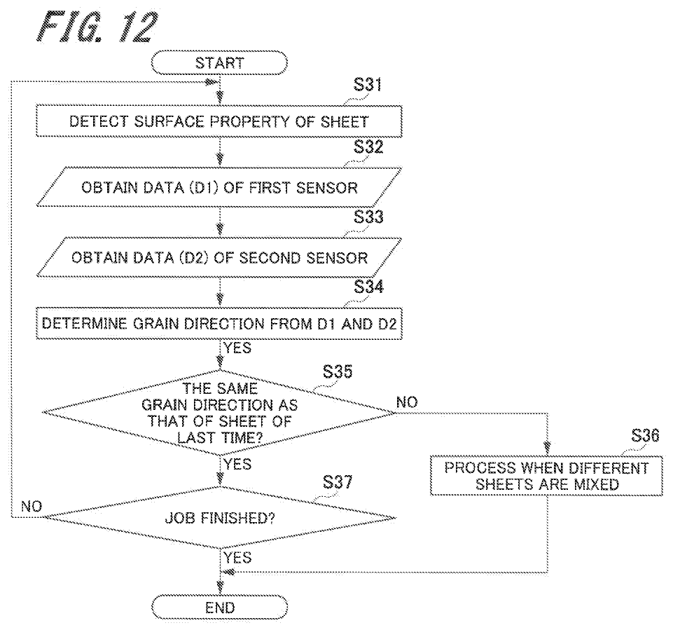

With reference to FIG. 12, another example of the operation of detecting a recording medium will now be described.

FIG. 12 is a flowchart illustrating the detecting operation as another example. In the detecting operation illustrated in FIG. 12, an example of using the detecting unit 50A according to the second embodiment as the detecting unit will be described. The example of the detecting operation illustrated in FIG. 12 is an operation example of performing an image forming process on a plurality of sheets S as a job which is set.

As illustrated in FIG. 12, the control unit 200 controls the detecting unit 50A to detect the surface property of the sheet S by using the first sensor 51A and the second sensor 51B (step S31). The control unit 200 obtains the surface property data (hereinafter, called first surface property data) D1 detected by the first sensor 51A (step S32). The control unit 200 obtains the surface property data (hereinafter, called second surface property data) D2 detected by the second sensor 51B (step S33).

The control unit 200 determines the grain direction of the sheet S from the first surface property data D1 and the second surface property data D2 (step S34). When it is determined that the value of the first surface property data D1 is larger than that of the second surface property data D2 in the process of step S34, the control unit 200 determines that the grain direction of the sheet S which is detected this time is Y grain. When it is determined that the value of the second surface property data D2 is larger than that of the first surface property data D1, the control unit 200 determines that the grain direction of the sheet S which is detected this time is T grain. The control unit 200 stores information regarding the determined grain direction into the memory 250.

Subsequently, the control unit 200 determines whether the grain direction of the sheet S detected this time is the same as that of the sheet S detected last time or not (step S35). The sheet S detected last time is the sheet S conveyed to the detecting unit 50A just before the sheet S detected at present.

When it is determined in the process of step S35 that the grain direction of the sheet S of last time and that of the sheet S of this time are not the same (NO determination in step S35), the control unit 200 executes a process when different sheets mixedly exist (step S36). The process at the time in which different sheets mixedly exit in step S36 is, for example, to display that the sheets S of different grain directions mixedly exist in the operation display panel 240 and to notify the user. The control unit 200 controls the sheet conveying unit 230 and conveys the sheet S detected this time to a sheet ejection tray different from that for the sheet S detected last time. When the process of step S36 is finished, the control unit 200 temporarily finishes the job.

When it is determined in the process of step S35 that the grain direction of the sheet S of last time and that of the sheet S of this time are the same (YES determination in step S35), the control unit 200 determines whether the job is finished or not (step S37). When the control unit 200 determines that the job is not finished in the process of step S37 (NO determination in step S37), the operation of detecting the sheet S to which the image forming process is performed next is performed. That is, return to the process of step S31 is performed to execute the above-described process again.

When the control unit 200 determines that the job is finished in the process of step S37 (YES determination in step S37), the operation of detecting the sheet S and the job are finished.

Also in the example of the detecting operation illustrated in FIG. 12, by detecting the grain direction of the sheet S, mixture of the sheets S of different grain directions can be prevented, and decrease in conveyance performance, load capacity, and the like of the sheet S can be suppressed.

The detecting operation illustrated in FIG. 12 is not limited to the image forming system of the second embodiment having the first sensor 51A and the second sensor 51B. The detecting operation illustrated in FIG. 12 can be performed also in the image forming system 1 according to the first embodiment in which the sensor 51 can be changed between the first arrangement state and the second arrangement state.

### 4. Third Embodiment

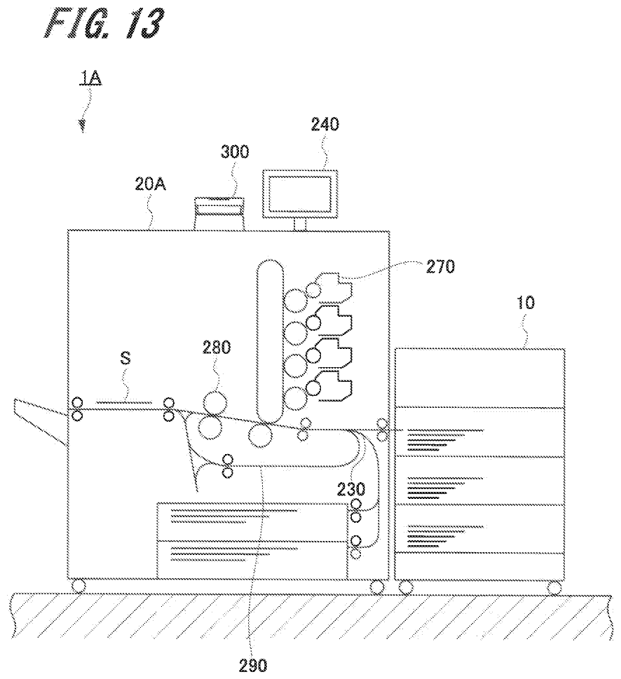

Next, an image forming system according to a third embodiment will be described with reference to FIGS. 13 to 16.

FIG. 13 is a schematic configuration diagram of an image forming system according to a third embodiment.

The image forming system according to the third embodiment is different from the image forming system 1 according to the first embodiment with respect to the point that a recording medium detecting device is connected detachably to the image forming device 20 on the outside of the image forming device 20. Consequently, the same reference numerals are designated to parts common to those in the image forming system 1 according to the first embodiment and repetitive description will not be given.

As illustrated in FIG. 13, an image forming system 1A has the sheet feeding unit 10, an image forming device 20A, and a recording medium detecting device 300. Since the configuration of the sheet feeding unit 10 is the same as that of the sheet feeding unit 10 in the first embodiment, its description will not be repeated. The image forming device 20A is obtained by eliminating the detecting unit 50 from the image forming device 20 in the first embodiment, and the other configuration is the same, so that the description will not be repeated.

The recording medium detecting device 300 is a recording medium detecting device of a so-called offline system. The recording medium detecting device 300 is detachably connected to the image forming device 20A. The recording medium detecting device 300 is connected to a network such as LAN and mutually connected to the image forming device 20A and the sheet feeding unit 10 via the network. The recording medium detecting device 300 is not limited to a detachable type but may be connected integrally to the image forming device 20A.

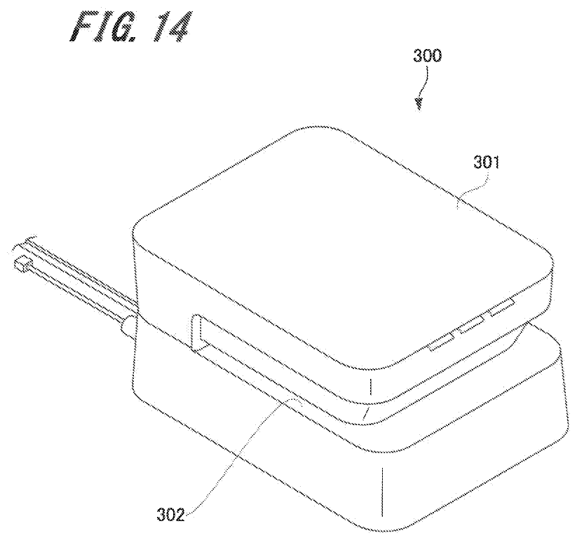

FIG. 14 is a perspective view illustrating the recording medium detecting device 300.

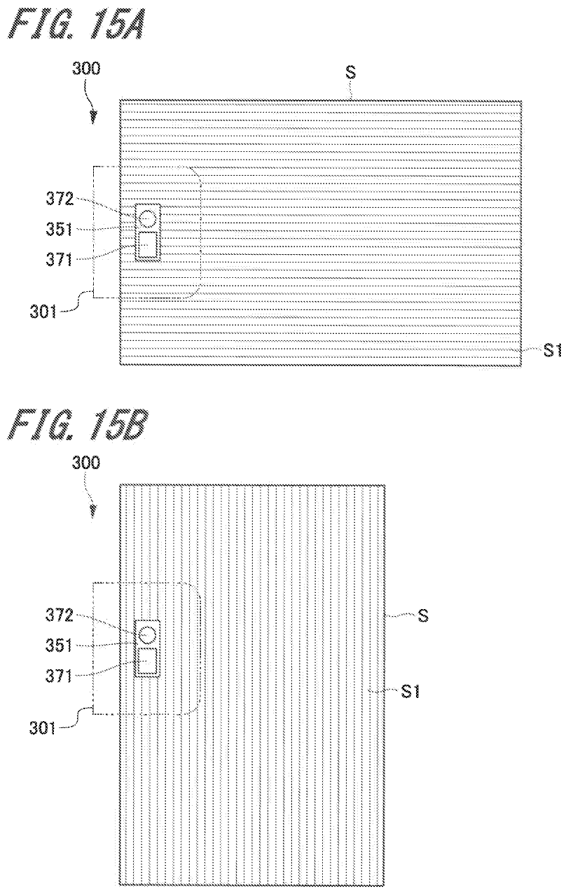

As illustrated in FIG. 14, the recording medium detecting device 300 has a sensor 351 (refer to FIGS. 15A and 15B), a detection unit 301 having therein the sensor 351, and a not-illustrated control unit. In the detection unit 301, an insertion port 302 in which the sheet S can be inserted by the user is formed.

FIGS. 15A and 15B are explanatory diagrams illustrating the sensor 351 of the recording medium detecting device 300.

As illustrated in FIGS. 15A and 15B, the sensor 351 has a light receiving unit 371 and a light emitting unit 372. The light receiving unit 371 receives light emitted from the light emitting unit 372 and reflected by the sheet S. The light receiving unit 371 and the light emitting unit 372 are mounted along a direction perpendicular to the direction of insertion to the insertion port 302 in the sheet S. Consequently, the detection direction of the sensor 351 is perpendicular to the insertion direction of the sheet S.

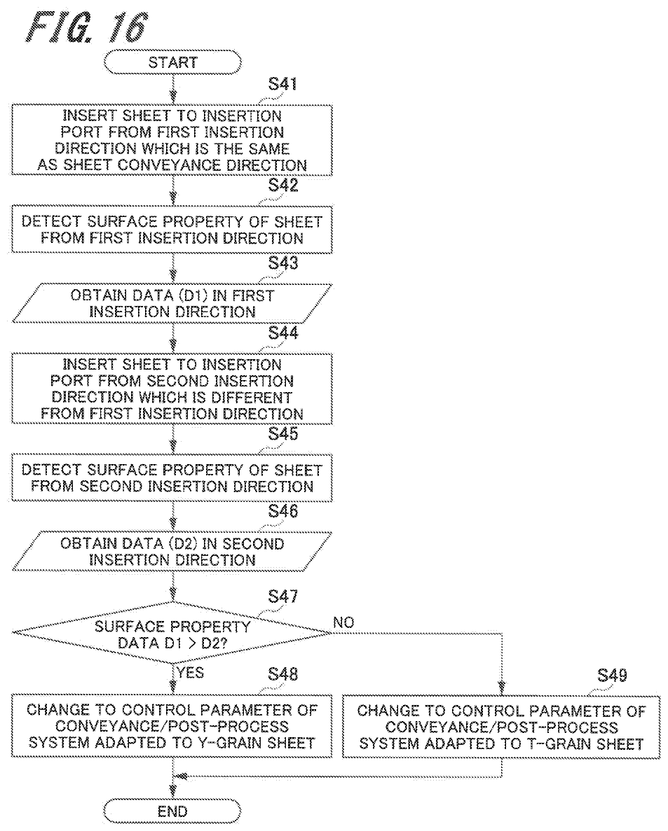

With reference to FIG. 16, operation of detecting a sheet in the image forming system according to the third embodiment will be described.

FIG. 16 is a flowchart illustrating an example of the detecting operation. The detecting operation illustrated in FIG. 16 is performed before the sheet S is set in the sheet feeding unit 10.

As illustrated in FIG. 16, the control unit 200 of the image forming device 20 notifies the user that the insertion of the sheet S to the insertion port 302 becomes the direction (hereinafter, called first insertion direction) which is the same as the conveyance direction of the sheet S in the image forming device 20. The method of notifying the user may be sound or display of information on the operation display panel 240 of the image forming device 20, or other various methods can be used. The user inserts the sheet S into the insertion port 302 from the first insertion direction which is the same as the conveyance direction of the sheet S (step S41).

As illustrated in FIG. 15A, when the sheet S is inserted to the insertion port 302 in the first insertion direction, the sensor 351 detects the surface properties of the sheet S (step S42). As described above, the insertion direction of the sensor 351 is perpendicular to the insertion direction of the sheet S. The control unit 200 of the image forming device 20 obtains the surface property data (hereinafter, called first surface property data) D1 in the first insertion direction detected by the sensor 351 (step S43).

When the first surface property data D1 is obtained, the control unit 200 of the image forming device 20 notifies the user so that the insertion direction of the sheet S to the insertion port 302 becomes a direction (hereinafter, called second insertion direction) different from the first insertion direction. In the embodiment, the second insertion direction indicates a direction perpendicular to the first insertion direction. However, the first and second insertion directions may not cross at right angles but may just cross each other. The user inserts the sheet S from the second insertion direction to the insertion port 302 (step S44).

As illustrated in FIG. 15B, when the sheet S is inserted to the insertion port 302 in the second insertion direction, the sensor 351 detects the surface property of the sheet S (step S45). The control unit 200 of the image forming device 20 obtains the surface property data (hereinafter, called second surface property data) D2 in the second insertion direction detected by the sensor 351 (step S46).

When the first surface property data D1 and the second surface property data D2 is obtained, the control unit 200 determines whether the value of the first surface property data D1 is larger than that of the second surface property data D2 (step S47). When it is determined in the process of step S47 that the value of the first surface property data D1 is larger than that of the second surface property data D2 (YES determination in step S47), the control unit 200 determines that the grain direction of the sheet S is the first insertion direction to the insertion port 302, that is, the Y grain perpendicular to the conveyance direction. The control unit 200 changes the control parameter to the control parameter of the conveyance/post-process system adapted to the sheet S of Y grain (step S48).

On the other hand, when it is determined in the process of step S47 that the value of the first surface property data D1 is not larger than that of the second surface property data D2 (NO determination in step S47), the control unit 200 determines that the grain direction of the sheet S is perpendicular to the second insertion direction to the insertion port 302. Since the second insertion direction is perpendicular to the conveyance direction, it is understood that the grain direction of the sheet S is T grain. The control unit 200 changes the control parameter to the control parameter of the conveyance/post-process system adapted to the sheet S of T grain (step S18). It completes the operation of detecting the sheet S by the image forming system 1A.

Although the example that the control unit 200 of the image forming device 20 makes determination has been described above, the present invention is not limited to the example. For example, the control unit of the recording medium detecting device 300 may detect the grain direction of the sheet S, perform the process of selecting the control parameter, and output the detected information and the selected control parameter to the control unit 200. After determining the grain direction of the sheet S, the recording medium detecting device 300 may notify the user of information regarding the grain direction of the sheet S by sound or via the operation display panel 240.

Although the example of notifying the user so that the first insertion direction becomes the conveyance direction in the process of step S41 has been described, the present invention is not limited to the example. For example, the control unit 200 or the recording medium detecting device 300 may determine that the insertion direction of the first time of the sheet S to the insertion port 302 is the conveyance direction.

As described above, the image forming system 1A to which the recording medium detecting device 300 of the offline type is connected also has actions and effects similar to those of the image forming system 1 according to the first embodiment.

### 5. Modifications

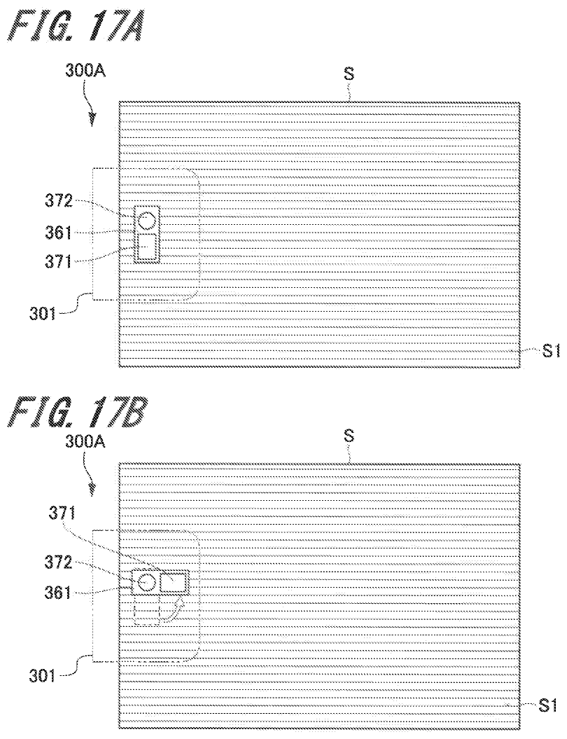

Next, a modification of the image forming system according to the third embodiment will be described with reference to FIGS. 17A and 17B. Since the point different from the image forming system 1A according to the third embodiment is only the sensor of the recording medium detecting device, the sensor will be described here, and description of the others will not be repeated.

FIGS. 17A and 17B are explanatory diagrams illustrating a modification of the recording medium detecting device.

As illustrated in FIGS. 17A and 17B, in the detecting unit 301 of a recording medium detecting device 300A, a sensor 361 is disposed. The sensor 361 has the light receiving unit 371 and the light emitting unit 372. Like the sensor 51 according to the first embodiment, the sensor 361 is configured so that it can be moved between the first arrangement state and the second arrangement state by a not-illustrated moving mechanism.

As illustrated in FIG. 17A, when the sensor 361 is in the first arrangement state, the light receiving unit 371 and the light emitting unit 372 are mounted along the direction perpendicular to the insertion direction of the sheet S to the insertion port 302. Consequently, when the sensor 361 is in the first arrangement state, the detection direction of the sensor 361 is perpendicular to the insertion direction of the sheet S. The detection direction of the sensor 361 at this time is set as the first detection direction. Since the sheet is inserted in the insertion port 302 in a direction parallel to the conveyance direction in the image forming device 20, the first detection direction of the sensor 361 is perpendicular to the conveyance direction of the sheet S.

As illustrated in FIG. 17B, when the sensor 361 is in the second arrangement state, the light receiving unit 371 and the light emitting unit 372 are mounted along the direction parallel to the insertion direction of the sheet S to the insertion port 302. Consequently, when the sensor 361 is in the second arrangement state, the detection direction of the sensor 361 is parallel to the insertion direction (conveyance direction) of the sheet S. The detection direction of the sensor 361 at this time is set as the second detection direction.

In the recording medium detecting device 300A according to the modification, when the sheet S is inserted in the insertion port 302, the sensor 361 detects the sheet S in the first arrangement state, after that, the arrangement state of the sensor 361 is changed to the second arrangement state, and the sheet S is detected. Consequently, in the recording medium detecting device 300A according to the modification, by inserting the sheet S only once to the insertion port 302, the surface property of the sheet S can be detected from two directions of the first and second detection directions. As a result, the first surface property data and the second surface property data can be obtained by the inserting operation of the sheet S of one time, and the grain direction of the sheet S can be detected.

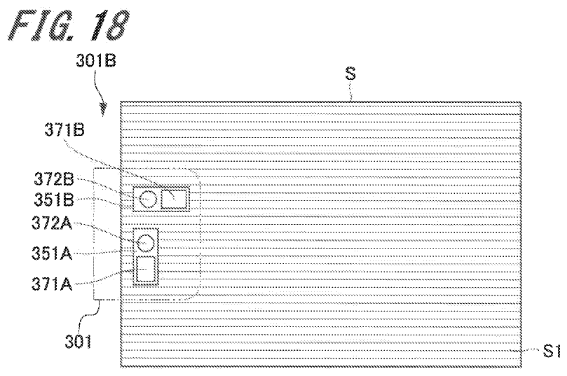

Further, another modification of the image forming system according to the third embodiment will be described with reference to FIG. 18. Since the point different from the image forming system 1A according to the third embodiment is only the sensor in the recording medium detecting device, the sensor will be described here and the description of the others will not be repeated.

FIG. 18 is an explanatory diagram illustrating another modification of the recording medium detecting device.

As illustrated in FIG. 18, in the detection unit 301 of a recording medium detecting device 300B, like the detecting unit 50A according to the second embodiment, a first sensor 351A and a second sensor 351B are mounted.

The first sensor 351A has a first light receiving unit 371A and a first light emitting unit 372A. The first light receiving unit 371A receives light emitted from the first light emitting unit 372A and reflected by the sheet S. The first light receiving unit 371A and the first light emitting unit 372A of the first sensor 351A are mounted along the direction perpendicular to the insertion direction of the sheet S to the insertion port 302. That is, the detection direction of the first sensor 351A is perpendicular to the insertion direction (conveyance direction) of the sheet S. The detection direction of the first sensor 351A is set as the first detection direction.

The second sensor 351B has a second light receiving unit 371B and a second light emitting unit 372B. The second light receiving unit 371B receives light emitted from the second light emitting unit 372B and reflected by the sheet S. The second light receiving unit 371B and the second light emitting unit 372B of the second sensor 351B are mounted along the direction parallel to the insertion direction of the sheet S to the insertion port 302. That is, the detection direction of the second sensor 51B is parallel to the insertion direction (conveyance direction) of the sheet S. The detection direction of the second sensor 51B is set as the second detection direction.

Also in the recording medium detecting device 300B according to another modification illustrated in FIG. 18, like the recording medium detecting device 300A according to the modification illustrated in FIG. 17, by inserting the sheet S only once to the insertion port 302, the grain direction of the sheet S can be detected. As a result, the operation performed by the user can be simplified.

The embodiments and their actions and effects have been described above. However, the present invention is not limited to the foregoing embodiments but various modifications can be employed without departing from the gist of the present invention described in the scope of claims for a patent.

Although the configuration of forming a color image by using four sets of image forming units has been described in the foregoing embodiments, the image forming device according to the present invention may also have a configuration of forming a monotone image by using one image forming unit.

Further, although the example of applying an image forming device of the electrophotographic type as the image forming device has been described, the present invention is not limited to the example. For example, an ink jet printer discharging ink toward a recording medium or other various image forming devices may be applied.

Further, although the example that reflection light which is reflected by a recording medium is received by the light receiving unit has been described in the foregoing embodiments, the present invention is not limited to the example. For example, the light receiving unit and the light emitting unit may be provided in positions opposed to each other via a recording medium. The light receiving unit receives light emitted from the light emitting unit and passed through the recording medium.

The display unit displaying a detection result of the detecting unit and the insertion direction in a recording medium detecting device of an offline type is not limited to the operation display panel 240. For example, the display unit may be provided for a recording medium detecting device, or a display unit of an external device (a client terminal, management device server, a mobile terminal, or the like) outputting job information to the image forming device 20 may be applied.

Although an example of applying the control unit 200 controlling the entire image forming device 20, which is mounted in a position different from the sensor as a control unit controlling the detecting unit has been described, the present invention is not limited to the example. A control unit for detection which controls the detecting unit may be provided separately from the control unit 200. The control unit for detection transmits/receives information of a detection result to/from the control unit 200, receives detecting operation from the control unit 200, and transmits a detection result to the control unit 200. A control parameter may be stored in the control unit for detection in accordance with the grain direction and the kind of a recording medium. Further, a control parameter may be stored in an external server and, when a recording medium is detected, the control parameter may be received from the external server.

A part or all of the above-described components, functions, processing units, and the like may be realized by hardware by, for example, designing of an integrated circuit. The components, functions, and the like may be realized by software by interpreting and executing a program realizing each function by a processor. Information of the program realizing each function, a table, a file, and the like can be stored in a recording device such as a memory, a hard disk, an SSD (Solid State Drive) or the like or a recording medium such as an IC card, an SD card, a DVD, or the like.

Although the example of applying a sheet as a recording medium has been described, the present invention is not limited to the example. As recording media, other various things such as a film and fabric can be applied.

Although the words such as “parallel” and “perpendicular” are used in the specification, the words are not limited to strict “parallel” and “perpendicular” but include “almost parallel” and “almost perpendicular” in a range in which the function can be displayed.

Although the embodiments of the present invention have been described and illustrated above, the disclosed embodiments are made for purposes of illustration and example only and not limitation. The scope of the present invention should be interpreted by the terms of the appended claims.

### DESCRIPTION OF REFERENCE NUMERALS

1, 1A . . . image forming system
10 . . . sheet feeding unit
20, 20A . . . image forming device
50, 50A . . . detecting unit (recording medium detecting device)
51, 51A, 51B, 351, 351A, 351B, 361 . . . sensor
71, 71A, 71B, 371, 371A, 371B . . . light receiving unit
72, 72A, 72B, 372, 372A, 372B . . . light emitting unit
200 . . . control unit
230 . . . sheet conveying unit
240 . . . operation display panel
250 . . . memory (storing unit)
260 . . . image processing unit
270 . . . image forming unit
290 . . . reverse conveying unit
300, 300A, 300B . . . recording medium detecting device
301 . . . detection unit
302 . . . insertion port
D1 . . . first surface property data
D2 . . . second surface property data
S . . . sheet (recording medium)
S1 . . . uneven parts

1. A recording medium detecting device comprising:
a sensor capable of detecting a recording medium from a first detection direction and a second detection direction different from the first detection direction; and
a control unit determining a grain direction of the recording medium from first surface property data obtained when the sensor detects the recording medium from the first detection direction and second surface property data obtained when the sensor detects the recording medium from the second detection direction.

2. The recording medium detecting device according to claim 1, further comprising a moving mechanism changing an arrangement state of the sensor between a first arrangement state in which a detection direction of the sensor is parallel to the first detection direction and a second arrangement state in which the detection direction of the sensor is parallel to the second detection direction.

3. The recording medium detecting device according to claim 1, wherein the sensor comprises:
a first sensor whose detecting direction of detecting the recording medium is the first detection direction; and
a second sensor whose detecting direction of detecting the recording medium is the second detection direction.

4. The recording medium detecting device according to claim 1, wherein the control unit changes a control parameter of a process which is performed on the recording medium in accordance with a grain direction of the recording medium determined.

5. The recording medium detecting device according to claim 1, wherein when the grain direction of a recording medium determined this time is different from the grain direction of a recording medium determined last time, the control unit performs a mix process on the recording medium determined this time.

6. The recording medium detecting device according to claim 1, wherein either the first detection direction or the second detection direction is parallel to a conveyance direction of the recording medium.

7. An image forming device comprising the recording medium detecting device according to claim 1.

8. The image forming device according to claim 7, wherein image forming device has the control unit.

9. An image forming system in which the recording medium detecting device according to claim 1 is connected to an image forming device forming an image on a recording medium.

10. A method of detecting a recording medium, comprising:
detecting a recording medium from a first detection direction;
detecting the recording medium from a second detection direction different from the first detection direction; and
determining a grain direction of the recording medium on the basis of first surface property data obtained when the recording medium is detected in the first detection direction and second surface property data obtained when the recording medium is detected in the second detection direction.

11. A non-transitory recording medium storing a computer readable program making a computer execute:
detecting a recording medium from a first detection direction by a sensor;
detecting the recording medium from a second detection direction different from the first detection direction by the sensor; and
determining a grain direction of the recording medium by a control unit on the basis of first surface property data obtained when the sensor detects the recording medium in the first detection direction and second surface property data obtained when the sensor detects the recording medium in the second detection direction.
